(19) United States
(12) Patent Application Publication
(10) Pub. No.: US 2007/0103414 A1
(43) Pub. Date: May 10, 2007

(54) Liquid crystal display device

(76) Inventors: Shinichi Aota, Ishikawa-gun (JP); Kenji Nakao, Kanazawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/528,541

(22) Filed: Sep. 28, 2006

(30) Foreign Application Priority Data
Sep. 30, 2005 (JP) 2005-288646
Sep. 26, 2006 (JP) 2006-260267

(51) Int. Cl. G09G 3/36

(52) U.S. Cl. 345/87

(57) ABSTRACT

A liquid crystal display device includes an OCB mode liquid crystal display panel in which a liquid crystal layer is held between a pair of electrode substrates, and a phase-transition voltage application circuit which provides an alternating phase-transition voltage which is applied to the liquid crystal layer to transition liquid crystal molecules from a splay alignment to a bend alignment in a phase-transition period. The phase-transition voltage application circuit includes a delay controller which delays a change of the alternating phase-transition voltage that leaves a center level.

### CROSS-REFERENCE TO RELATED APPLICATIONS

This application is based upon and claims the benefit of priority from prior Japanese Patent Applications No. 2005-288646, filed Sep. 30, 2005; and No. 2006-260267, filed Sep. 26, 2006, the entire contents of both of which are incorporated herein by reference.

### BACKGROUND OF THE INVENTION

1. Field of the Invention

The present invention relates to a liquid crystal display device which uses an optically compensated bend (OCB) mode liquid crystal display panel for displaying an image.

2. Description of the Related Art

In recent years, in the field of, e.g. large-sized liquid crystal TVs, attention has been drawn to OCB mode liquid crystal display panels having high liquid crystal responsivity that is needed for displaying moving images.

The OCB mode liquid crystal display panel includes an array substrate which includes a plurality of pixel electrodes arrayed in a matrix and covered with an alignment film; and a counter-substrate which includes a counter-electrode disposed to face the pixel electrodes and covered with an alignment film; and a liquid crystal layer which is held in contact with the alignment films between the array substrate and the counter-substrate. Further, a pair of polarizers are attached to the array substrate and the counter-substrate via optical retardation films (see, e.g. Jpn. Pat. Appln. KOKAI Publication No. 9-185032).

In the case where the liquid crystal display panel is of an active matrix type, the array substrate further includes a plurality of gate lines which are disposed along the rows of pixel electrodes, a plurality of source lines which are disposed along the columns of pixel electrodes, and a plurality of switching elements which are disposed near intersections of the gate lines and source lines. The respective gate lines are connected to a gate driver which drives the gate lines. The respective source lines axe connected to a source driver which drives the source lines. The gate driver and source driver are controlled by a controller. Each of the switching elements is composed of, e.g. a thin-film transistor (TFT), and is made conductive when the associated gate line is driven by the gate driver, so as to apply a pixel voltage, which is set on the associated source line by the source driver, to the associated pixel electrode. The counter-substrate further includes a color filter which is formed of striped color layers that are colored in red, green and blue and are arranged to face the columns of pixel electrodes. A pair of each pixel electrodes and the counter-electrode constitutes a liquid crystal pixel, together with a pixel region that is a part of the liquid crystal layer which is located between these electrodes. A driving voltage for the pixel is a difference between a pixel voltage, which is applied to the pixel electrode, and a common voltage which is applied to the counter-electrode. Even after the switching element is turned off, the driving voltage is held between the pixel electrode and the counter-electrode. The alignment of liquid crystal molecules in the pixel region is determined by an electric field corresponding to the driving voltage and controls the transmittance of the pixel. The polarity reversal of the driving voltage is executed, for example, by cyclically reversing the polarity of the. pixel voltage with respect to the common voltage. This reverses the direction of electric field and prevents non-uniform distribution of liquid crystal molecules in the liquid crystal layer.

In the meantime, in the OCB mode liquid crystal display panel, as shown in FIG. 21, the alignment of liquid crystal molecules needs to be transitioned in advance from a splay alignment to a bend alignment which is capable of performing a display operation. In general, the alignment of liquid crystal molecules is initialized to the bend alignment by an initializing process which is executed immediately after supply of power. In this initializing process, a phase-transition voltage, which is greater than a driving voltage at the time of display, is applied to the liquid crystal layer. Thereby, the alignment of liquid crystal molecules is transitioned from the splay alignment to the bend alignment. This phase-transition voltage can be obtained by the waveform of the common voltage which varies, for example, as shown in FIG. 22.

However, in the prior art, the above-described OCB mode liquid crystal display panel has such a problem that many extinguishable luminescent spots occur at the time of power supply in the manufacturing process of products that are equipped with the display panel. The extinguishable luminescent spots are luminescent spots that appear at non-specified. locations on the display screen, and disappear if the display screen is struck.

### BRIEF SUMMARY OF THE INVENTION

The present invention has been made in consideration of the above-described problems, and the object of the invention is to provide a liquid crystal display device which can suppress occurrence of extinguishable luminescent spots.

According to an aspect of the present invention, there is provided a liquid crystal display device comprising; an OCB mode liquid crystal display panel in which a liquid crystal layer is held between a pair of electrode substrates; and a phase-transition voltage application circuit which provides an alternating phase-transition voltage which is applied to the liquid crystal layer to transition liquid crystal molecules from a splay alignment to a bend alignment in a phase-transition period, wherein the phase-transition voltage application circuit includes a delay controller which delays a change of the alternating phase-transition voltage that leaves a center level.

In this liquid crystal display device, the delay controller delays a change of the alternating phase-transition voltage that leaves a center level. According to the inventor's study, it was found that electrically conductive foreign matter exists at locations where extinguishable luminescent spots occur. It is difficult to completely prevent such electrically conductive foreign matter from mixing between the electrode and alignment film shown in FIG. 22 in the manufacturing process.

The location where the electrically conductive foreign matter exists is now referred to as an electrically conductive foreign matter part. An electric field concentrates at the electrically conductive foreign matter part when the phase-transition voltage is applied. Positive ions and negative ions are not uniformly distributed near an interface between one of the electrode substrates and the liquid crystal layer and near an interface between the other electrode substrate and the liquid crystal layer, and many ions are condensed at a location corresponding to the electrically conductive foreign matter part. This condensing also occurs due to floating foreign matter. In this state, the direction of electric field by the phase-transition voltage from outside is opposite to the direction of electric field by the internal ions, but each of the electric fields is strong at the location corresponding to the electrically conductive foreign matter part. Further, if the polarity of the phase-transition voltage is reversed, the directions of these electric fields become equal and a strong combined electric field is generated. Consequently, the positive ions and negative ions in the liquid crystal layer are short-circuited without passing through the alignment films on the electrodes. This causes leakage of light which is observed as the luminescent spot. The short-circuit state of positive ions and negative ions is disturbed by striking the display screen. If leakage of light is eliminated as the result of the disturbance, the luminescent spot disappears. In the OCB mode liquid crystal display panel, the phase-transition voltage, which is greater than the driving voltage for normal display, is applied to the liquid crystal layer in order to obtain the bend alignment. Thus, an adequate margin cannot be secured with respect to the withstand voltage of the liquid crystal layer, unlike a twisted nematic (TN) mode liquid crystal display panel. However, if a change of the alternating phase-transition voltage that leaves a center level is delayed, as described above, one of short-circuit factors between positive and negative ions is removed. As a result, short-circuit hardly occurs between ions even when the other short-circuit factors remain, and the occurrence of extinguishable luminescent spots is suppressed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the circuit structure of a liquid crystal display device according to an embodiment of the present invention;

FIG. 2 is a waveform diagram that illustrates the operation of a phase-transition voltage control circuit which is composed of a phase-transition voltage setting unit and a counter-electrode driver shown in FIG. 1;.

FIG. 3 is a graph showing a relationship between a change time of the. alternating phase-transition voltage and a resistance of resistors shown in FIG. 1;

FIG. 4 is a waveform diagram of the alternating phase-transition voltage obtained when the resistances shown in FIG. 1 are set to a resistance of 470Ω;

FIG. 5 is a waveform diagram of the alternating phase-transition voltage obtained when the resistances shown in FIG. 1 are set to a resistance of 2.4 kΩ;

FIG. 6 is a waveform diagram of the alternating phase-transition voltage obtained when the resistances shown in FIG. 1 are set to a resistance of 4.7 kΩ;

FIG. 7 is a waveform diagram of the alternating phase-transition voltage obtained when the resistances shown in FIG. 1 are set to a resistance of 5.1 kΩ;

FIG. 8 is a waveform diagram of the alternating phase-transition voltage obtained when the resistances shown in FIG. 1 are set to a resistance of 5.6 kΩ;

FIG. 9 is a waveform diagram of the alternating phase-transition voltage obtained when the resistances shown in FIG. 1 are set to a resistance of 6.2 kΩ;

FIG. 10 is a-waveform diagram of the alternating phase-transition voltage obtained when the resistances shown in FIG. 1 are set to a resistance of 6.8 kΩ;

FIG. 11 is a waveform diagram of the alternating phase-transition voltage obtained when the resistances shown in FIG. 1 are set to a resistance of 7.5 kΩ;

FIG. 12 is a waveform diagram of the alternating phase-transition voltage obtained when the resistances shown in FIG. 1 are set to a resistance of 8.2 kΩ;

FIG. 13 is a waveform diagram of the alternating phase-transition voltage obtained when the resistances shown in FIG. 1 are set to a resistance of 8.8 kΩ;

FIG. 14 is a plan view showing comb-teeth end portions which are provided on pixel electrodes shown in FIG. 1;

FIG. 15 shows, together with electrode voltages, a lateral electric field and a vertical electric field, which are applied to a liquid crystal layer shown in FIG. 1;

FIG. 16 shows growth of a bend alignment which is obtained when the pixel electrode and counter-electrode are driven, as shown in FIG. 4, by providing nuclei of transition which is shown in FIG. 3;

FIG. 17 is a waveform diagram showing an operation which is obtained in a first modification of the phase-transition voltage application circuit shown in FIG. 1;

FIG. 18 is a waveform diagram showing an operation which is obtained in a second modification of the phase-transition voltage application circuit shown in FIG. 1;

FIG. 19 is a waveform diagram showing an operation which is obtained in a third modification of the phase-transition voltage application circuit shown in FIG. 1;

FIG. 20 is a waveform diagram showing an operation which is obtained in a fourth modification of the phase-transition voltage application circuit shown in FIG. 1;

FIG. 21 is a view for explaining an initializing process of an OCB mode liquid crystal display panel; and

FIG. 22 is a view for explaining the reason for occurrence of extinguishable luminescent spots on the OCB mode liquid crystal display panel.

### DETAILED DESCRIPTION OF THE INVENTION

A liquid crystal display device according to an embodiment of the present invention will now be described with reference to the accompanying drawings.

FIG. 1 schematically shows the circuit structure of the liquid crystal display device 100. The liquid crystal display device 100 is connected to an image information processing unit SG which serves as an external signal source in, e.g. a TV set or a mobile phone. The image information processing unit SG performs an image information process, and supplies a sync signal and a display signal to the liquid crystal display device 100.

The liquid crystal display device 100 includes a liquid crystal display panel DP having a plurality of OCB liquid crystal pixels PX which are arrayed substantially in a matrix, a backlight BL which illuminates the liquid crystal display panel DP, and a driving circuit DR which drives the liquid crystal display panel DP and backlight BL. The liquid crystal display panel DP includes an array substrate AR, a counter-substrate CT. and a liquid crystal layer LQ. The array substrate AR includes a plurality of pixel electrodes PE, which are formed on a transparent insulating substrate such as a glass plate, and an alignment film which covers the pixel electrodes PE. The counter-substrate CT includes a color filter layer which is formed on a transparent insulating substrate such as a glass plate, a counter-electrode CE which is formed on the color filter layer, and an alignment film which covers the counter-electrode CE. The liquid crystal layer LQ is obtained by filling a liquid crystal into a gap between the counter-substrate CT and the array substrate AR. The color filter layer includes a red color layer for red pixels, a green color layer for green pixels, a blue color layer for blue pixels, and a black color (light-shielding) layer for a black matrix. The liquid crystal display panel DP further includes a pair of retardation films which are disposed on outer sides of the array substrate AR and counter-substrate CT, and a pair of polarizers which are disposed on outer,sides of the retardation films. The backlight BL is disposed as a light source on the outside of the array substrate AR side polarizer. The alignment film on the array substrate AR side and the alignment film on the counter-substrate CT side are subjected to rubbing treatment in directions parallel to each other.

In the array substrate AR, the pixel electrodes PE are arrayed substantially in a matrix on the transparent insulating substrate. In addition, a plurality of gate lines Y (Y1 to Ym) are arranged along the rows of pixel electrodes PE, and a plurality of source lines X (X1 to Xn) are arranged along the columns of pixel electrodes PE. A plurality of pixel switching elements W are disposed near intersections of the gate lines Y and source lines X. Each of the pixel switching elements W is composed of, e.g. a thin-film transistor, which has a gate 28 connected to the gate line Y and a source-drain path connected between the source line X and pixel electrode PE. The pixel switching element W is made conductive between the associated source line X and associated pixel electrode PE when the pixel switching element W is driven via the associated gate line Y.

Each of the liquid crystal pixels PX includes a liquid crystal capacitance Clc constituted by the associated pixel electrode PE, the counter-electrode CE, and the liquid crystal layer LQ located between the associated pixel electrode PE and the counter electrode CE. Each of storage capacitance lines Cst (C1 to Cm) is capacitive-coupled to the pixel electrodes PE of the liquid crystal pixels PX of the associated row, to constitute storage capacitances Cs.

The driving circuit DR is configured to control the transmittance of the liquid crystal display panel DP by a liquid crystal driving voltage which is applied from the array substrate AR and counter-substrate CT to the liquid crystal layer LQ. Each OCB liquid crystal pixel PX is provided as a pixel corresponding to the range of the associated pixel electrode PE. In the OCB liquid crystal pixel PX, the alignment of liquid crystal molecules needs to be transitioned from a splay alignment to a bend alignment which is capable of displaying an image, by applying a high phase-transition voltage which is different from a normal driving voltage, for example. Thus, the driving circuit DR is configured to perform initialization for transitioning the alignment of liquid crystal molecules from the splay alignment to the bend alignment by applying the phase-transition voltage to the liquid crystal layer LQ as a liquid crystal driving voltage each time power is supplied. In the present specification, the term “OCB” refers to the bend alignment, that is a state where birefringence in one direction can be optically self-compensated, for example. Optical compensation of birefringence is attainable by only the bend alignment, and also by a combination of optical films and the like. The term “OCB liquid crystal pixel” refers to a pixel which is a liquid crystal display element for displaying an image by using liquid crystal molecules aligned in the bend alignment.

The driving circuit DR includes, for example, a gate driver YD which sequentially drives the gate lines Y so as to turn on the switching elements W on a row-by-row basis; a source driver XD which outputs pixel voltages Vs to the source lines X during a time period in which the switching elements W of each row are turned on by the driving of the associated gate line Y; a counter-electrode driver 3 which drives the counter-electrode CE of the liquid crystal display panel DP; a backlight driving unit BD which drives the backlight BL: and a controller 1 which controls the gate driver YD, source driver XD and backlight driving unit BD.

The controller 1 outputs to the gate driver YD a vertical timing control signal which is generated on the basis of a sync signal input from the image information processing unit SG. The controller 1 also outputs to the source driver XD a horizontal timing control signal and pixel data for one horizontal line, which are generated on the basis of the sync signal and display signal input from the image information processing unit SG. Further, the controller 1 outputs a turn-on control signal to the backlight driving unit SD. Under the control of the vertical timing control signal, the gate driver YD sequentially drives the gate lines Y in one frame period and outputs to the selected gate line Y a gate driving voltage which turns on the pixel switching elements W of each row for 1 horizontal scanning period H. Under the control of the horizontal timing control signal, the source driver XD converts the pixel data for one horizontal line to pixel voltages Vs and outputs the pixel voltages Vs to the source lines X in parallel for 1 horizontal scanning period H in which the gate driving voltage is output to the selected gate line Y.

The pixel voltages Vs are voltages that are applied to the pixel electrodes PE using a common voltage Vcom, which is output from the counter-electrode driver 3 to the counter-electrode CE, as a reference. The polarities of the pixel voltages Vs are reversed relative to the common voltage Vcom in every predetermined period. For example, in a frame-reversal drive scheme, the polarities of the pixel voltages Vs are reversed relative to the common voltage Vcom in every frame period. In a line-reversal drive scheme, the polarities of the pixel voltages Vs are reversed relative to the common voltage Vcom, in units of one or more horizontal pixel lines. When the switching elements W for one row are turned off, the gate driver YD applies a compensation voltage to the storage capacitance line Cst which corresponds to the gate line Y to which these switching elements W are connected, thereby compensating variations in pixel voltages Vs occurring for one horizontal pixel line due to an influence caused by parasitic capacitances of the switching elements W.

In the liquid crystal display device 100, the driving circuit DR includes a phase-transition voltage setting unit 2 which sets an alternating phase-transition voltage for transitioning the-alignment of liquid crystal molecules from the splay alignment to the bend alignment in an initializing process immediately after power supply. In order to obtain the alternating phase-transition voltage, the phase-transition voltage setting unit 2 generates a positive voltage VDDH of, e.g. +30V and a negative voltage VSSD of −20V, and outputs the voltages to the counter-electrode driver 3 from first and second output terminals, respectively. The counter-electrode driver 3 includes a switch S which effects switching between the common voltage Vcom that is supplied from the controller 1 for the display operation, the positive voltage VDOH that is supplied from the first output terminal of the phase-transition voltage setting unit 2, and the negative voltage VSSD that is supplied from the second output terminal of the phase-transition voltage setting unit 2; and a pair of resistors R which are connected, respectively, between the first output terminal of the phase-transition voltage setting unit 2 and the switch S and between the second output terminal of the phase-transition voltage setting unit 2 and the switch S. The phase-transition voltage setting unit 2 is configured to control the switch S in the initializing process such that the common voltage Vcom is temporarily changed to the alternating phase-transition voltage. In this example, the phase-transition voltage setting unit 2 and counter-electrode driver 3 constitute a phase-transition voltage application circuit which applies to the liquid crystal layer LQ an alternating phase-transition voltage for transitioning the liquid crystal molecules from the splay alignment to the bend alignment. The switch S and the pair of resistors R constitute a delay controller which delays a change of the alternating phase-transition voltage that leaves a center level, in order to remove one of short-circuit factors between positive and negative ions which are locally concentrated in association with electrically conductive foreign matter in the vicinity of an interface between the paired array substrate AR and liquid crystal layer LQ and an interface between the paired counter-substrate CT and liquid crystal layer LQ.

Specifically, in the initializing process, an alternating phase-transition voltage with a waveform shown in a lower part of FIG. 2 is output from the counter-electrode driver 3. In the counter-electrode driver 3, the switch S first selects the negative VSSD for a period of about 500 ms (at a time of normal temperature), and then selects the positive voltage VDDH similarly for a period of about 500 ms (at a time of normal temperature). Thereby, the phase-transition voltage changes from +5V, which is a center level (AVDD/2) of a voltage difference AVDD between the positive voltage VDDH and negative voltage VSSD, to −20V, and then changes to +30V. If the paired resistors R are not provided, the alternating phase-transition voltage changes, as shown in an upper part of FIG. 2. In this case, the fall time of the phase-transition voltage (i.e. change time from +5V to −20V) and the rising time (i.e. change time from +5V to +30V) is about 10 to 20 ms. The paired resistors R have a resistance which lengthens the change time, and make gentler the falling and rising of the waveform of the phase-transition voltage. This means that one of the short-circuit factors between the positive and negative ions is removed by relaxing the local concentration of positive and negative ions.

FIG. 3 shows a relationship between a change time of the alternating phase-transition voltage and a resistance of resistors R. Experiments were conducted with respect to various resistances for resistors R, under conditions where the phase-transition period=1 sec (reset time excluded), room temperature=25° C., VDDH=+30V, and VSSD=−20V. The relationship was obtained based on the results of experiments shown in FIGS. 4 to 13. According to the results, it is apparent that the change time is proportional to the resistance of the resistors R, that the rise time is 1.38 times as long as the fall time, on average, and that a ripple of the alternating phase-transition voltage, which is present near the maximum amplitude level (−20V or +30V), increases with an increase in the resistance. In every experiment, phase-transition from the splay alignment to the bend alignment was carried out, along with thinning out of the short-circuit factors between the positive and negative ions.

However, in the case where a significant ripple exists in the alternating phase-transition voltage, the circuit operation may become unstable and insufficient phase-transition may occur due to ambient temperature.

Referring to the results of experiments, it is desirable that a delay (change time) for falling to the negative polarity is set within a range of 3 to 30% of a part of the phase-transition period in which the negative polarity is maintained. It is more desirable that the delay is set within a range of 10 to 20%. Similarly, it is desirable that a delay (change time) for rising to the positive polarity is set within a range of 3 to 30% of a part of the phase-transition period in which the positive polarity is maintained. It is more preferable that the delay is set within a range of 10 to 20%. This is effective in avoiding short-circuit between positive and negative ions and causing the ripple of the alternating phase-transition voltage to fall within an acceptable range. To eliminate necessity of increasing the phase-transition period, it is desirable that the delay (change time) for falling is set to be not longer than 150 ms, more desirably, 100 ms.

When the paired resistors R have a resistance of 4.7 KΩ under the above conditions, the delay for falling to the negative polarity and the delay for rising to the positive polarity are set to 60 ms (12%) and 84 ms (17%), with respect to the phase-transition period of 1 sec. Thus, expected effects can be attained.

In the meantime, since the phase-transition voltage is applied as the common voltage Vcom to the counter-electrode CE, the pixel voltage Vs that is applied to each pixel electrode PE is related to the actual driving voltage that is applied to the liquid crystal layer LQ. The pixel voltage Vs of each pixel electrode PE may be kept at a constant value in the transition period in which the alternating phase-transition voltage for transitioning the alignment of liquid crystal molecules from the splay alignment to bend alignment is applied. However, in order to reduce the transition period, it is preferable to positively use the pixel voltage Vs of each pixel electrode PE. Specifically, comb-teeth end portions, for example, as shown in FIG. 14, are provided in each pixel electrode PE in the column direction, and pixel voltages Vs1 and Vs2, which are complementary, are applied to two neighboring pixel electrodes PE in the column direction in the phase-transition period as shown in FIG. 15. In this example, the pixel voltages Vs1 and Vs2 are applied to the neighboring pixel electrodes PE as pulses which cyclically vary between 0V and 10V at opposite phases. Thereby, if a lateral electric field is applied from the comb-teeth end portions of the neighboring pixel electrodes PE to the liquid crystal layer LQ, the splay alignment of liquid crystal molecules is partly changed to a twist alignment. The liquid crystal molecules easily transition from the twist alignment to the bend alignment by a vertical electric field that is applied from each pixel electrode PE and counter-electrode CE to the liquid crystal layer LQ. Thus, the upper-side comb-teeth end portion and lower-side comb-teeth end portion of the pixel electrode PE shown in FIG. 14 become nuclei of transition to the bend alignment. If a bend alignment occurs in the vicinity of the nuclei of transition, the bend alignment quickly grows toward the center of the pixel PX, as shown in FIG. 16. In this case, the total phase-transition period can be decreased to about 600 ms.

To shorten a period required for transition from the splay alignment to the bend alignment, it is effective that the splay alignment of liquid crystal molecules is partly changed to a twist alignment. Further, it is also effective that the lateral or slanted electric field described above is applied. Specifically, it is preferable that the electric field is applied between the electrodes of a comb-teeth shape described above. With the electrodes, it can be considered that the electric field is applied not only in one direction with respect to the alignment direction of the liquid crystal molecules, but also in various direction.

FIG. 17 shows an operation which is obtained in a first modification of the phase-transition voltage application circuit. In this modification, if it is confirmed from the detection result of a temperature sensor 10 that the ambient temperature of the liquid crystal display panel DP is, e.g. about −20° C., the phase-transition voltage setting unit 1 sets the phase-transition period at about 5 seconds, which enable exact transition from the splay alignment to bend alignment, varies the positive voltage VDDH from +30V to +25V, and varies the negative voltage VSSD from −20V to −15V. If the voltage amplitude of the phase-transition voltage at low temperatures is decreased in this manner, the electric field that is applied to the liquid crystal layer LQ is relaxed and the short-circuit factors between positive and negative ions can be thinned.

FIG. 18 shows an operation which is obtained in a second modification of the phase-transition voltage application circuit. In this modification, the counter-electrode driver 3 is controlled so that the phase-transition voltage setting unit 2 may output only the negative voltage VSSD of −20V as the phase-transition voltage. If the phase-transition voltage is prevented from being reversed in polarity in this manner, the direction of electric field by the phase-transition voltage from the outside of the liquid crystal layer 11 is always the same as the direction of electric field by ions in the inside of the liquid crystal layer LQ. Thus, the short-circuit factors between positive and negative ions are thinned. In this case, however, the liquid crystal molecules in the liquid crystal layer LQ may non-uniformly be distributed as the supply of power is repeated. It is thus preferable to adopt, for example, a scheme in which the polarity of the phase-transition voltage is reversed each time power is supplied.

FIG. 19 shows an operation which is obtained in a third modification of the phase-transition voltage application circuit. In this modification, the structure of the comb-teeth end portions shown in FIG. 14 is used, and the phase-transition voltage setting unit 2 sets the phase-transition period at, e.g. about 0.7 second, which is shorter than 1 second. Thereby, the amount of locally condensed positive and negative ions is reduced, and the short-circuit factors between positive and negative ions are thinned.

FIG. 20 shows an operation which is obtained in a fourth modification of the phase-transition voltage application circuit. In this modification, the phase-transition voltage setting unit 2 controls the counter-electrode driver 3 so as to alternately output the positive voltage VDDH and negative voltage VSSD twice or more in the transition period. Thereby, non-uniform distribution of locally concentrated positive and negative ions in the vicinity of the interfaces between the respective substrates is suppressed, and the short-circuit factors between positive and negative ions are thinned.

In addition, the first to fourth modifications of the phase-transition voltage application circuit are used in combination with the technique that delays a change of the phase-transition voltage in the manner described with reference to FIG. 2.

According to the present embodiment, if the phase-transition voltage is made to have such a waveform as to thin the short-circuit factors between positive and negative ions, as described above, short-circuit hardly occurs between ions due to the remaining short-circuit factors, and the occurrence of extinguishable luminescent spots can be suppressed.

The above-described phase-transition voltage application circuit may be so constructed as to execute a combination of the controls described in the respective modifications.

In the embodiment described above, the switch S and the pair of resistors R constitute a delay controller which delays a change of the alternating phase-transition voltage that leaves a center level. Thus, the phase-transition voltage gradually changes from the center level ADVV/2 (+5V) to VDDH (=+30V) or VSSD (=−20V). Instead, the switch S and the phase-transition voltage setting unit 2 may be used as the delay controller which delays a change of the alternating phase-transition voltage that leaves a center level. In this case, the phase-transition voltage setting unit 2 outputs positive and negative voltages whose absolute value increases from ADVV/2 (+5V) to VDDH (=+30V) or VSSD (=−20V) in a step-by-step manner, and the switch S switches the positive and negative voltages. It is desirable that the change time for falling to the negative polarity is set within a range of 6 to 7% of the phase-transition period; the change time for rising to the positive polarity is set within a range of 8 to 10%; and the change time for falling to the negative polarity, the change time for rising to the positive polarity, the positive voltage, and the negative voltage are equally divided. Two or three is sufficient as the number of division. In the case where the phase-transition period=1 sec and the change time for falling to the negative polarity, the change time for rising to the positive polarity, the positive voltage, and the negative voltage are divided into two parts, respectively, the negative and positive voltages are output in an increment of 12.5V (absolute value) for each period of about 30 ms and 40 ms, for example.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising:
an OCB mode liquid crystal display panel in which a liquid crystal layer is held between a pair of electrode substrates; and
a phase-transition voltage application circuit which provides an alternating phase-transition voltage which is applied to said liquid crystal layer to transition liquid crystal molecules from a splay alignment to a bend alignment in a phase-transition period;
wherein said phase-transition voltage application circuit includes a delay controller which delays a change of the alternating phase-transition voltage that leaves a center level.

2. The liquid crystal display device according to claim 1, wherein said delay controller includes a resistive means for providing negative and positive voltages which are selectively output as the alternating phase-transition voltage in the phase-transition period.

3. The liquid crystal display device according to claim 2, wherein the resistive means is a pair of resistors which are inserted in an output line for the negative voltage and an output line for the positive voltage, respectively.

4. The liquid crystal display device according to claim 3, wherein said pair of resistors have a resistance which is determined such that a change time of the alternating phase-transition voltage for a change to the negative voltage is set within a range of 3 to 30% of a part of the phase-transition period in which the negative polarity is maintained, and a change time of the alternating phase-transition voltage for a change to the positive voltage is set within a range of 3 to 30% of a part of the phase-transition period in which the positive polarity is maintained.

5. The liquid crystal display device according to claim 1, wherein said delay controller includes a voltage setting unit which provides negative and positive voltages which are selectively output as the alternating phase-transition voltage in the phase-transition period and whose absolute values increase in a step-by-step manner.

6. The liquid crystal display device according to claim 5, wherein said voltage setting unit is configured such that a change time of the alternating phase-transition voltage for a change to the negative voltage is set within a range of 3 to 30% of a part of the phase-transition period in which the negative polarity is maintained, and a change time of the alternating phase-transition voltage for a change to the positive voltage is set within a range of 3 to 30% of a part of the phase-transition period in which the positive polarity is maintained.

7. The liquid crystal display device according to claim 6, wherein said voltage setting unit is configured to make an increment of the negative voltage constant in the change time of the alternating phase-transition voltage for a change to the negative voltage and an increment of the positive voltage constant in the change time of the alternating phase-transition voltage for a change to the positive voltage.

8. A liquid crystal display device comprising:
an OCB mode liquid crystal display panel including an array substrate on which a plurality of pixel electrodes are arrayed in a matrix, a counter-substrate having a counter-electrode, and a liquid crystal layer held between said array substrate and said counter-substrate; and
a phase-transition voltage application circuit which provides an alternating phase-transition voltage which is applied to said counter-electrode to transition liquid crystal molecules from a splay alignment to a bend alignment in a phase-transition period;
wherein said phase-transition voltage application circuit includes a delay controller which delays a change of the alternating phase-transition voltage that leaves a center level.

9. The liquid crystal display device according to claim 8, wherein said array substrate includes an electric field applying member which applies, to liquid crystal molecules in said liquid crystal layer, an electric field which is parallel or slanted with respect to a substrate plane.

10. The liquid crystal display device according to claim 9, wherein said electric field applying member is constituted by neighboring ones of said pixel electrodes.

11. The liquid crystal display device according to claim 10, wherein said neighboring pixel electrodes constituting said electric field applying member include comb-teeth end portions associated with each other.
